(19) United States
(12) Patent Application Publication
(10) Pub. No.: US 2024/0265490 A1
(43) Pub. Date: Aug. 8, 2024

(54) Machine Learning Models for Image Interpolation

(71) Applicant: Google LLC, Mountain View, CA (US)

(72) Inventors: Janne Matias Kontkanen, San Francisco, CA (US); Eric Tabellion, Belmont, CA (US); Brian Lee Curless, Seattle, WA (US); Fitsum Reda, Santa Clara, CA (US); Deqing Sun, Boston, MA (US); Caroline Rebecca Pantofaru, San Carlos, CA (US)

(21) Appl. No.: 18/436,509

(22) Filed: Feb. 8, 2024

Related U.S. Application Data
(60) Provisional application No. 63/483,850, filed on Feb. 8, 2023.

(51) Int. Cl. G06T 3/4007; G06T 3/18; G06T 7/246

(52) U.S. Cl. CPC G06T 3/4007; G06T 3/18; G06T 7/248; G06T 2207/20081

(57) ABSTRACT

Provided is a computer system that includes one or more processors and one or more non-transitory computer-readable media that collectively store a machine-learned image interpolation model. The machine-learned image interpolation model is configured to: extract, for each of multiple different scales, a respective set of feature values from each of a pair of input images; generate, for each of the multiple different scales, a respective flow estimate for each of the pair of input images that indicates a respective flow from the interpolation time to the respective capture time; warp, for each of the multiple different scales, the respective set of feature values for each of the pair of input images according to the respective flow estimate to generate respective warped sets of features; and generate a interpolated image based on the respective warped sets of features for the pair of input images and the multiple different scales.

### RELATED APPLICATIONS

This application claims priority to and the benefit of U.S. Provisional Patent Application No. 63/483,850, Filed Feb. 8, 2023. U.S. Provisional Patent Application No. 63/483,850 is hereby incorporated by reference in its entirety.

### FIELD

The present disclosure relates generally to machine learning. More particularly, the present disclosure relates to the use of machine learning models for performing image interpolation, including between pairs of images that exhibit large amounts of relative motion.

### BACKGROUND

The task of image interpolation includes synthesizing one or more intermediate images between a pair of input images. Image interpolation can also be referred to as frame interpolation and input images can be referred to as input frames. Image interpolation is an important problem with increasing reach. It is often used for temporal up-sampling to increase refresh rate or create slow-motion videos.

Recently, a new use case has emerged. Digital photography, especially with the advent of smartphones, has made it effortless to take several photographs within a few seconds, and people naturally do so often in their quest for just the right photo that captures the moment. These “near duplicates” create an exciting opportunity: interpolating between them can lead to surprisingly engaging videos that reveal scene (and some camera) motion, often delivering an even more pleasing sense of the moment than any one of the original photos.

Unlike video, however, the temporal spacing between near duplicate photographs can be a second or more, with commensurately large scene motion, posing a major challenge for existing interpolation methods. Frame interpolation between consecutive video frames, which often exhibit small motion, has been studied extensively, and recent methods show impressive results for this scenario.

However, little attention has been given to interpolation for large scene motion, commonly present in near duplicates. In particular, certain works attempt to handle large motion by training on 4K sequences with extreme motion. While this approach provides adequate results in the narrow training setting, it does not generalize well on regular footage. Conversely, other approaches may provide high image quality with small motion, but cannot handle large motion well. Yet other approaches perform poorly when the test motion range deviates from the training motion range. Thus, existing techniques fail to generalize to a range of image inputs and amounts of motion.

Furthermore, various prior approaches to image interpolation often rely on the inclusion of additional, pre-trained models to supplement a primary trained model. For example, certain recent works introduce a depth network to handle occlusions, incorporate motion estimation modules, or rely on pre-trained features. While impressive results are achieved with these approaches, multiple networks can make training processes complex. These approaches may also need scarce data to pre-train the prior networks. Pre-training datasets, e.g. optical flows, are even very scarce for large motion.

### SUMMARY

Aspects and advantages of embodiments of the present disclosure will be set forth in part in the following description, or can be learned from the description, or can be learned through practice of the embodiments.

One example aspect of the present disclosure is directed to a computer system for image interpolation. The computer system includes one or more processors and one or more non-transitory computer-readable media that collectively store a machine-learned image interpolation model. The machine-learned image interpolation model is configured to receive and process a pair of input images having respective capture times to generate an interpolated image having an interpolation time. The machine-learned image interpolation model is configured to: extract, for each of multiple different scales, a respective set of feature values from each of the pair of input images; generate, for each of the multiple different scales, a respective flow estimate for each of the pair of input images that indicates a respective flow from the interpolation time to the respective capture time; warp, for each of the multiple different scales, the respective set of feature values for each of the pair of input images according to the respective flow estimate to generate respective warped sets of features; and generate the interpolated image based on the respective warped sets of features for the pair of input images and the multiple different scales.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts an example machine-learned image interpolation model according to example embodiments of the present disclosure.

FIG. 1B depicts an example machine-learned image interpolation model according to example embodiments of the present disclosure.

FIG. 2A depicts a block diagram of an example computing system according to example embodiments of the present disclosure.

FIG. 2B depicts a block diagram of an example computing device according to example embodiments of the present disclosure.

FIG. 2C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to machine learning models for performing image interpolation, including between pairs of images that exhibit large amounts of relative motion. One example application of the proposed approach is a frame interpolation algorithm that synthesizes an engaging slow-motion video from near-duplicate photos which often exhibit large scene motion. Near-duplicates interpolation is an interesting new application, but large motion poses challenges to existing methods. To address this issue, example implementations of the present disclosure leverage a feature extractor that shares weights across the scales and also include a novel “scale-agnostic” motion estimator. The proposed motion estimator relies on the intuition that large motion at finer scales should be similar to small motion at coarser scales, which boosts the number of available pixels for large motion supervision. To inpaint wide disocclusions caused by large motion and synthesize crisp frames, example implementations optimize the proposed network with the Gram matrix loss that measures the correlation difference between features. To simplify the training process, example implementations include a unified single-network approach that removes the reliance on additional optical-flow or depth network and is trainable from frame triplets alone.

More particularly, example aspects of the present disclosure propose an image interpolation model that generalizes well to both small and large motion. Specifically, example models include a multi-scale feature extractor that shares weights across the scales. The present disclosure also provides a novel “scale-agnostic” bi-directional motion estimation module. The proposed motion estimation module relies on the intuition that large motion at finer scales should be similar to small motion at coarser scales, thus increasing the number of pixels (as finer scale is higher resolution) available for large motion supervision. This approach is effective in handling large motion by simply training on regular frames.

Further, while the state-of-the-art methods score well on benchmarks, the interpolated frames often appear blurry, especially in large disoccluded regions that arise from large motions. Therefore, example implementations of the present disclosure optimize the image interpolation model with the Gram matrix loss, which matches the auto-correlation of the high-level VGG features, and significantly improves the realism and sharpness of frames. Thus, one technical effect and benefit of the present disclosure is to improve the quality (e.g., realism and sharpness) of the synthesized interpolated imagery (e.g., particularly in situations involving large motion and/or large disoccluded regions). As such, the present disclosure represents and improvement in the functioning of a computer system (e.g., that synthesizes interpolated imagery).

Another drawback of recent interpolation methods is training complexity, because they typically rely on scarce data to pre-train additional optical flow, depth, or other prior networks. Such data scarcity is even more critical for large motion. For example, certain other approaches may incorporate a depth network, or use additional networks to estimate per-pixel motion. In contrast, to simplify the training process, another contribution of the present disclosure is a unified architecture for frame interpolation, which is trainable from regular frame triplets alone. Thus, another technical effect and benefit of the present disclosure is to provide a model that generates high quality results but has a relatively lower training complexity compared to current state of the art models. By reducing training complexity, the present disclosure can conserve computational resources such as processor usage, memory usage, and/or network bandwidth. Therefore, the present disclosure represents an improvement in computational efficiency for image interpolation.

In summary, example implementations of the present disclosure provide the following benefits: One example aspect of the present disclosure expands the scope of frame interpolation to a novel near-duplicate photos interpolation application. Another example aspect of the present disclosure includes a multi-scale feature extractor that shares weights, and proposes a scale-agnostic bi-directional motion estimator to handle both small and large motion well, using regular training frames. Another example aspect of the present disclosure adopts a Gram matrix-based loss function to inpaint large disocclusions caused by large scene motion, leading to crisp and pleasing frames. Finally, another example aspect of the present disclosure provides a unified, single-stage architecture, to simplify the training process and remove the reliance on additional optical flow or depth networks.

With reference now to the Figures, example embodiments of the present disclosure will be discussed in further detail.

### Example Image Interpolation Models

### Example Model Architectures

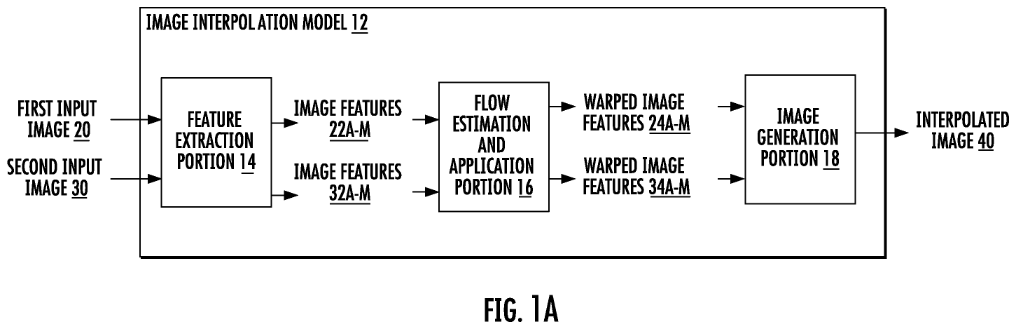

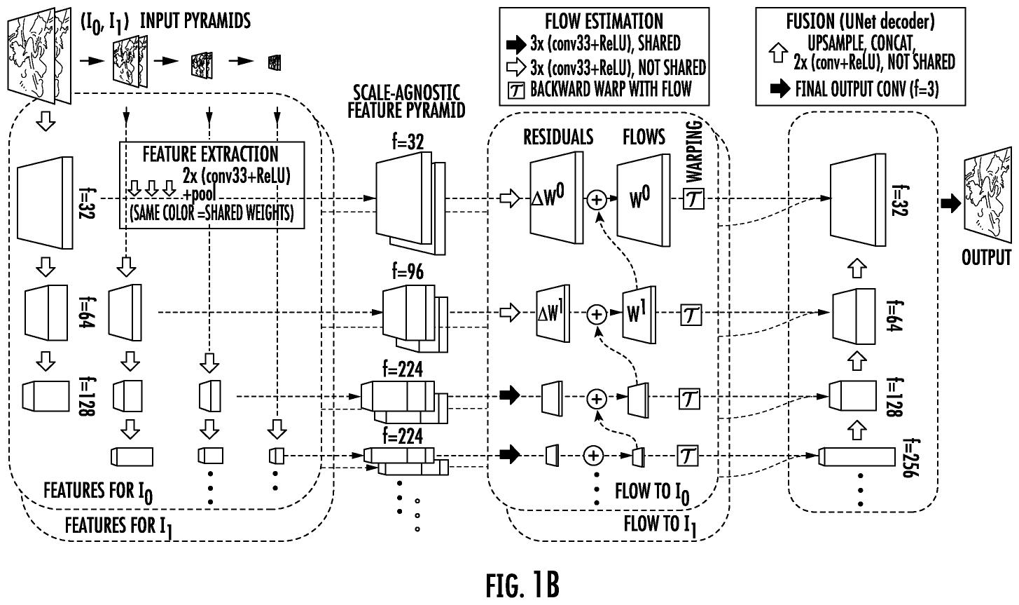

FIG. 1A depicts an example machine-learned image interpolation model 12 according to example embodiments of the present disclosure. The machine-learned image interpolation model 12 can include a feature extraction portion 14, a flow estimation and application portion 16, and an image generation portion 18.

The machine-learned image interpolation model 12 can be configured to receive and process a pair of input images 20 and 30 having respective capture times. For example, the capture time of image 20 can be represented as time 0, while the capture time of image 30 can be represented as time 1. The model 12 can process the input images 20 and 30 to generate an interpolated image 40 having an interpolation time. For example, the interpolation time can be represented as time t.

In some implementations, the pair of input images 20 and 30 can be near-duplicate photographs. For example, in some implementations, the respective capture times for the pair of input images 20 and 30 can be at least one second apart from each other.

Referring still to FIG. 1, the feature extraction portion 14 can extract, for each of multiple different scales, a respective set of feature values from each of the pair of input images. The scales can be represented by the letters a-m, where the magnitude of m is a configurable hyperparameter, and where a is the finest scale and m is the coarsest scale. Thus, for image 20, the feature extraction portion 14 can extract image features 22a-m, where a-m correspond to the different image scales or resolutions. Likewise, for image 30, the feature extraction portion 14 can extract image features 32a-m. For example, for image 30 and scale l, a set of features can be represented by F₁^{l}.

In some implementations, the feature extraction portion 14 can include and apply a plurality of learned convolutional filters associated with a plurality of different scales. In some implementations, at least two of the convolutional filters for at least two of the different scales can include shared weight values.

The flow estimation and application portion 16 can generate, for each of the multiple different scales a-m, a respective flow estimate for each of the pair of input images 20 and 30. For each image and each scale, the flow estimate can indicate a respective flow from the interpolation time to the respective capture time. For example, for image 30 and scale l, a flow estimate W_{t→1}^{l} can indicate a respective flow from time t to time 1 for scale l.

In some implementations, to generate each respective flow estimate, the flow estimation and application portion 16 is configured to apply one or more learned convolutional filters. In some implementations, weights for the convolutional filters can be shared across scales. Thus, for two or more of the multiple different scales, the learned convolutional filters comprise shared weight values.

The flow estimation and application portion 16 can warp, for each of the multiple different scales a-m, the respective set of feature values 22a-m and 32a-m for each of the pair of input images 20 and 30 according to the respective flow estimate to generate respective warped sets of features. For example, for image 20, the flow estimation and application portion 16 can warp the image features 22a-m according to the estimated flow to generate warped image features 24a-m. Likewise, for image 30, the flow estimation and application portion 16 can warp the image features 32a-m according to the estimated flows to generate warped image features 34a-m. For example, for image 30 and scale l, the flow estimation and application portion 16 can warp F₁^{l} according to W_{t→1}^{l} to obtain warped image features F_{t←1}^{l}. In some implementations, warping the respective set of feature values for each of the pair of input images according to the respective flow estimate can include performing a backward warping operation such as a backward bilinear resample operation.

The image generation portion 18 can generate the interpolated image 40 based on the respective warped sets of features 24a-m and 34a-m for the pair of input images 20 and 30. In some implementations, the image generation portion 18 can generate the interpolated image 40 based on the respective warped sets of features 24a-m and 34a-m for the pair of input images 20 and 30 and also based on the respective flow estimate for each of the pair of input images and the multiple different scales.

In some implementations, the image generation portion 18 is configured to apply one or more learned convolutional filters to the respective warped sets of features 24a-m and 34a-m for the pair of input images 20 and 30 to generate the interpolated image 40.

FIG. 1B depicts an example machine-learned image interpolation model 52 according to example embodiments of the present disclosure. The example model 52 is one example approach for implementing the model 12 of FIG. 1A. In particular, given two input images (I₀, I₁), with large in-between motion, the example model 52 can synthesize a mid-image [symbol] , with time t∈(0,1), as:

$$= M ( {I}_{0} , {I}_{1} ) , \qquad ( 1 )$$

where [symbol] is an example image interpolation model 52 trained with ground truth imagery. During training, one example setting is t=0.5 and more in-between images can be predicted by recursively invoking or running the model 52.

A common approach to handle large motion is to employ feature pyramids, which increases receptive fields. However, a standard pyramid learning has two difficulties: 1) small fast-moving objects disappear at coarse levels, and 2) the number of pixels is drastically smaller at coarse levels (i),

$$( \frac{H}{{2}^{i}} \times \frac{W}{{2}^{i}} ) ,$$

which means there are fewer pixels to provide large motion supervision. To overcome these challenges, some example implementations of the model 52 can share the convolution weights across the scales. Based on the intuition that large motion at finer scales should be the same as small motion at coarser scales, sharing weights allows the model 52 to boost the number of pixels available for large motion supervision.

The example model 52 has three main stages: Shared feature extraction, scale-agnostic motion estimation, and a fusion stage that outputs the resulting color image.

Feature Extraction: The model 52 includes a feature extractor that allows weight sharing across the scales, to create a “scale-agnostic” feature pyramid. It is constructed in three steps as follows.

First, the model 52 creates image pyramids {I₀^{l}} and {I₁^{l}} for the two input images, where l∈[1,7] is the pyramid level.

Second, starting at the image at each l-th pyramid level, the model 52 build feature pyramids (the columns in FIG. 1B) using a shared UNet encoder. Specifically, the model 52 extracts multi-scale features {f₀^{l,d}} and {f₁^{l,d}}, with d∈[1,4] being the depth at that l-th level (Figure ‘B only uses d∈[1,3] for illustration). This can be expressed as,

$${f}_{0}^{l , d} = {H}^{d} ( {I}_{0}^{l} ) \qquad ( 2 )$$

where [symbol] is a stack of convolutions, shown in FIG. 1B with differently shaded arrows for d=1, d=2, and d=3. Note that, the same [symbol] convolution weights can be shared for the same d-th depth at each pyramid level, to create compatible multiscale features. Each [symbol] ^{d} can be followed by an average pooling with a size and stride of e.g., 2.

As a third and final step of the example feature extractor, the model 52 can construct scale-agnostic feature pyramids, {F₀^{l}} and {F₁^{l}}, by concatenating the feature maps with different depths, but the same spatial dimensions, as:

$${F}_{0}^{l} = ( {f}_{0}^{l - 2 , d = 3} , {f}_{0}^{l - 1 , d = 2} , {f}_{0}^{l , d = 1} ) , \qquad ( 3 )$$

and the scale-agnostic feature, F₁^{l} of I₁, at the l-th pyramid level, can be given in a similar way by Equation 3. As shown in FIG. 1B, the finest level feature may in some implementations only aggregate one feature map, the second finest level two, and the rest can aggregate three shared feature maps.

Flow Estimation: Once the model 52 extracts the feature pyramids, {F₀^{l}} and {F₁^{l}}, the model 52 can use them to calculate a bi-directional motion at each pyramid level. For example, the model 52 can start the motion estimation from the coarsest level (in one example case l=7). However, in contrast to other methods, the model 52 can directly predict task oriented flows, W_{t→0} and W_{t→1}, from the mid-frame to the inputs.

In particular, in some implementations, the model 52 can compute the task oriented flow at each level W_{t→1}^{l} as the sum of predicted residual and the upsampled flow from the coarser level l+1, based on the intuition that large motion at finer scales should be the same as small motion at coarser scales, as:

$${W}_{t \to 1}^{l} = {( {W}_{t \to 1}^{l + 1} )}_{\times 2} + {𝒢}^{l} ( {F}_{0}^{l} , {F}_{t ← 1}^{l} ) , \qquad ( 4 )$$

where (•)_{×2} is a bilinear up-sampling, [symbol] is a stack of convolutions that estimates the residual, and F_{t←1}^{l} is the backward warped scale-agnostic feature map at t=1, obtained by bilinearly warping F₁^{l} with the upsampled flow estimate, as,

$${F}_{t ← 1}^{l} = 𝒯 ( {F}_{1}^{l} , {( {W}_{t \to 1}^{l + 1} )}_{\times 2} ) , \qquad ( 5 )$$

with [symbol] being a bilinear resample (warp) operation. FIG. 1B depicts [symbol] ^{l} by the shaded or unshaded arrows, depending on the pyramid level. Note that, the same residual convolution weights [symbol] can be shared by certain (e.g., levels l∈[3,7]). Finally, the model 52 can create the feature pyramid at the intermediate time t, {F_{t←1}^{l}} and {F_{t←0}^{l}}, by backward warping the feature pyramid, at t=1 and t=0, with the flows given by Equation 4, as:

$${F}_{t ← 1}^{l} = 𝒯 ( ( {F}_{1}^{l} , {l}_{1}^{l} ) , {W}_{t \to 1}^{l} ) , \qquad ( 6 )$$

F_{t←0}^{l} can be given in a similar way as Equation 6.

Fusion: The final stage of the model 52 can concatenates, at each l-th pyramid, the scale-agnostic feature maps at t and the bi-directional motions to t, which can then be fed to a decoder (e.g., which may have a U-Net style architecture) to synthesize the final mid-frame [symbol] . Mathematically, the fused input at each l-th decoder level is given by,

$$( {F}_{t ← 1}^{l} , {F}_{t ← 0}^{l} , {W}_{t \to 0}^{l} , {W}_{t \to 1}^{l} ) . \qquad ( 7 )$$

FIG. 1B illustrates the decoder's convolutions and resulting activations with a white arrow and gray boxes, respectively.

### Example Loss Functions

Some example implementations use only image synthesis losses to supervise the final output of the image interpolation model (e.g., 12 or 52). Thus, some implementations do not use auxiliary losses tapped into any intermediate stages. In some implementations, the image synthesis loss can be a combination of three terms.

First, an L1 reconstruction loss can be used that minimizes the pixel-wise RGB difference between the interpolated frame [symbol] and the ground-truth frame Iₜ, given by:

$${ℒ}_{1} = {‖ - {I}_{t} ‖}_{1} . \qquad ( 8 )$$

The [symbol] ₁ loss captures the motion between the inputs (I₀, I₁) and yields interpolation results that score well on benchmarks. However, the interpolated frames may be blurry.

Therefore, second, to enhance image details, some implementations can add a perceptual loss, using the L1 norm of the VGG-19 features. The perceptual loss, also called VGG-loss, [symbol] _{VGG}, is given by,

$${ℒ}_{VGG} = \frac{1}{L} {\sum }_{l = 1}^{L} {α}_{l} {‖ {Ψ}_{l} ( ) - {Ψ}_{l} ( {I}_{t} ) ‖}_{1} , \qquad ( 9 )$$

where Ψₗ(Iᵢ)∈ [symbol] ^{H×W×C} is the features from the l-th selected layer of a pre-trained Imagenet VGG-19 network for I∈ [symbol] ^{H×W×3}, L is the number of the finer layers considered, and αₗ is an importance weight of the l-th layer.

Finally, some example implementations employ a style loss to further expand on the benefits of [symbol] _{VCG}. The style loss [symbol] _{Gram}, also called Gram matrix loss, is the L2 norm of the auto-correlation of the VGG-19 features:

$${ℒ}_{Gram} = \frac{1}{L} {\sum }_{l = 1}^{L} {α}_{l} {‖ {M}_{l} ( ) - {M}_{l} ( {l}_{t} ) ‖}_{2} , \qquad ( 10 )$$

where the Gram matrix of the interpolated frame at the l-th layer, Mₗ( [symbol] )∈ [symbol] ^{C×C}, is given by:

$${M}_{l} ( \overline{{l}_{c}} ) = {( {Ψ}_{l} ( \overline{{l}_{c}} ) )}^{ú} ( {Ψ}_{l} ( \overline{{l}_{c}} ) ) , \qquad ( 11 )$$

and the Gram matrix of the ground-truth image, Mₗ(Iₜ), can be given in a similar way as Equation 11.

The present disclosure is the first work that applies the Gram matrix loss to frame interpolation. This loss is effective in synthesizing sharp images with rich details when inpainting large disocclusion regions caused by large scene motion. To achieve high benchmark scores as well as high quality frame synthesis, some example implementations train the image interpolation models with an optimally weighted combination of the RGB, VGG and Gram matrix losses. The combined loss, which can be denoted Ls, can be defined as,

$${ℒ}_{S} = {w}_{l} {ℒ}_{1} + {w}_{VGG} {ℒ}_{VGG} + {w}_{Gram} {ℒ}_{Gram} , \qquad ( 12 )$$

with the weights (wₗ,w_{VGG},w_{Gram}) determined empirically or set manually.

### Example Devices and Systems

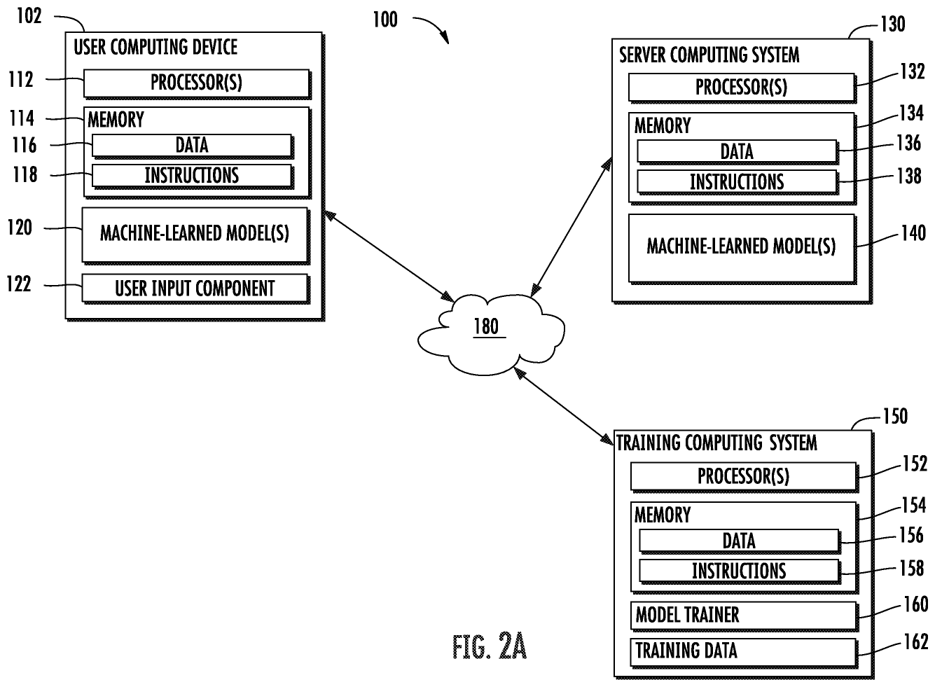

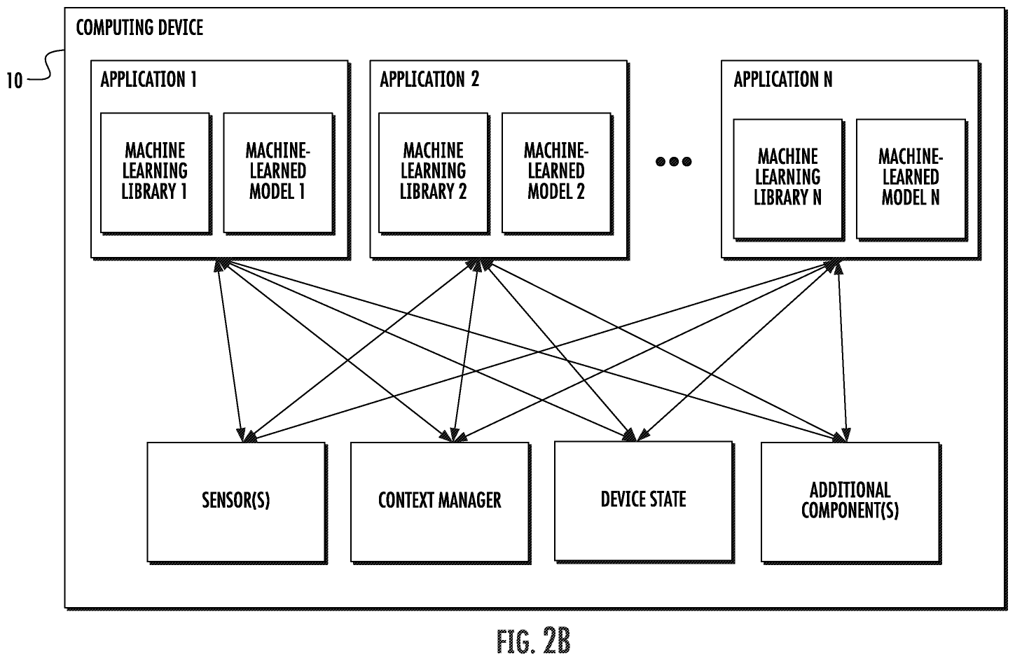

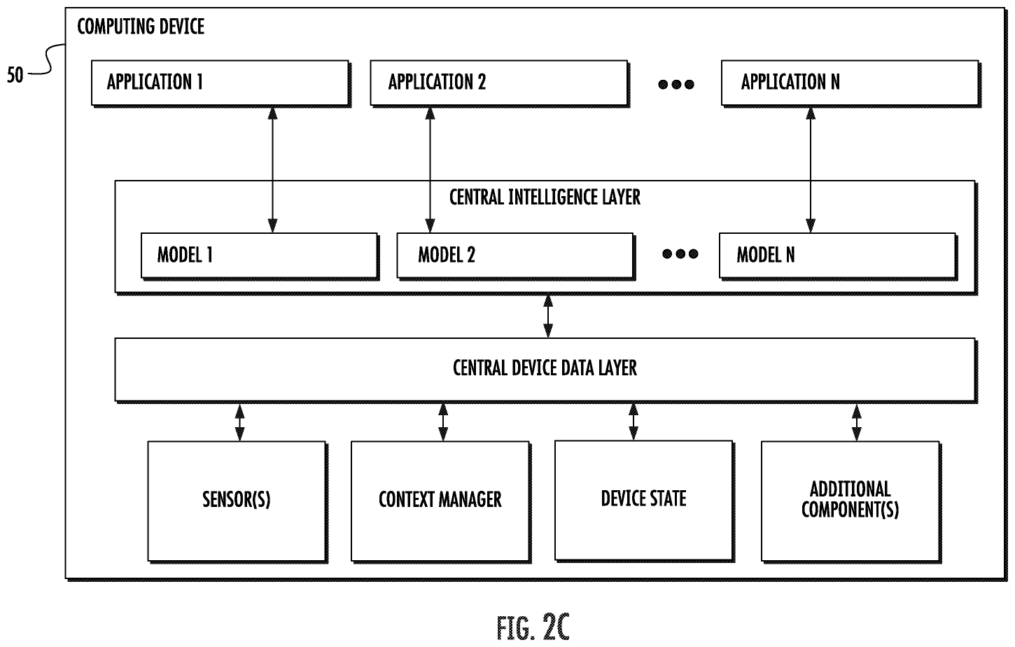

FIG. 2A depicts a block diagram of an example computing system 100 that performs image interpolation according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned image interpolation models 120. For example, the machine-learned image interpolation models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned image interpolation models 120 are discussed with reference to FIGS. 1A-B.

In some implementations, the one or more machine-learned image interpolation models 120 can be received from the server computing system 130 over network 180, stored in the user computing device memory 114, and then used or otherwise implemented by the one or more processors 112. In some implementations, the user computing device 102 can implement multiple parallel instances of a single machine-learned image interpolation model 120 (e.g., to perform parallel image interpolation across multiple instances of input images).

Additionally or alternatively, one or more machine-learned image interpolation models 140 can be included in or otherwise stored and implemented by the server computing system 130 that communicates with the user computing device 102 according to a client-server relationship. For example, the machine-learned image interpolation models 140 can be implemented by the server computing system 140 as a portion of a web service (e.g., an image interpolation service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned image interpolation models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1A-B.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned image interpolation models 120 and/or 140 based on a set of training data 162. The training data 162 can include, for example, a plurality of training tuples, where each training tuple comprises a first input image, a second input image, and a ground truth image. For example, the training tuple can be generated from three consecutive images (e.g., included in a video or otherwise contemporaneously captured). That is, the ground truth image may not necessarily have been interpolated from the first and second training images, but may, in some implementations, simply be an image captured at a time between the first and second training images.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 2A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 2B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 2B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 2C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 2C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 2C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer system for image interpolation, the computer system comprising:
one or more processors; and
one or more non-transitory computer-readable media that collectively store a machine-learned image interpolation model configured to receive and process a pair of input images having respective capture times to generate an interpolated image having an interpolation time, wherein the machine-learned image interpolation model is configured to:
extract, for each of multiple different scales, a respective set of feature values from each of the pair of input images;
generate, for each of the multiple different scales, a respective flow estimate for each of the pair of input images that indicates a respective flow from the interpolation time to the respective capture time;
warp, for each of the multiple different scales, the respective set of feature values for each of the pair of input images according to the respective flow estimate to generate respective warped sets of features; and
generate the interpolated image based on the respective warped sets of features for the pair of input images and the multiple different scales.

2. The computer system of claim 1, wherein to generate, for each of the multiple different scales, the respective flow estimate for each of the pair of input images the machine-learned image interpolation model is configured to, for each of the multiple different scales except a coarsest scale:
predict a residual based on (1) the set of feature values for the other input image and the scale and (2) a warped version of the set of feature values for the input image and the scale, wherein the warped version of the set of feature values for the input image and the scale has been warped according to an upsampled flow estimate for the input image from a coarser scale; and
generate the flow estimate for the input image and the scale based on the residual and the upsampled flow estimate for the input image from the coarser scale.

3. The computer system of claim 2, wherein to predict the residual the machine-learned image interpolation model is configured to apply one or more learned convolutional filters to (1) the set of feature values for the other input image and the scale and (2) the warped version of the set of feature values for the input image and the scale.

4. The computer system of claim 3, wherein, for two or more of the multiple different scales, the learned convolutional filters comprise shared weight values.

5. The computer system of claim 1, wherein to warp, for each of the multiple different scales, the respective set of feature values for each of the pair of input images according to the respective flow estimate, the machine-learned image interpolation model is configured to perform a backward bilinear resample operation.

6. The computer system of claim 1, wherein to extract, for each of the multiple different scales, the respective set of feature values from each of the pair of input images the machine-learned image interpolation model applies a plurality of learned convolutional filters associated with a plurality of different scales, and wherein at least two of the convolutional filters for at least two of the different scales comprise shared weight values.

7. The computer system of claim 1, wherein to generate the interpolated image based on the respective warped sets of features for the pair of input images and the multiple different scales the machine-learned image interpolation model is configured to generate the interpolated image based on the respective warped sets of features for the pair of input images and the multiple different scales and further based on the respective flow estimate for each of the pair of input images and the multiple different scales.

8. The computer system of claim 1, wherein to generate the interpolated image based on the respective warped sets of features for the pair of input images and the multiple different scales the machine-learned image interpolation model is configured to apply one or more learned convolutional filters to the respective warped sets of features for the pair of input images and the multiple different scales.

9. The computer system of claim 1, wherein the pair of input images comprise near-duplicate photographs.

10. The computer system of claim 1, wherein the respective capture times for the pair of input images are at least one second apart from each other.

11. The computer system of claim 1, wherein the machine-learned image interpolation model has been trained using a loss function that comprises: a L1 loss term, a perceptual loss term, and style loss term.

12. The computer system of claim 1, wherein the machine-learned image interpolation model has been trained using a loss function that comprises a style loss term, wherein the style loss term evaluates a Gram matrix that measures a correlation difference between features.

13. The computer system of claim 1, wherein the machine-learned image interpolation model comprises a single machine-learned model trained end-to-end.

14. A computer-implemented to perform machine learning, the method comprising:
obtaining, by a computing system comprising one or more computing devices, a training tuple comprising a pair of input images and a ground truth image;
processing, by the computing system, the pair of input images with the machine-learned image interpolation model described in any of claims 1-13 to generate a predicted interpolated image;
evaluating, by the computing system, a loss function that generates a loss value based on the ground truth image and the predicted interpolated image; and
modifying, by the computing system, one or more values of one or more parameters of the machine-learned image interpolation model based on the loss function.

15. One or more non-transitory computer-readable media that collectively store a machine-learned image interpolation model configured to receive and process a pair of input images having respective capture times to generate an interpolated image having an interpolation time, wherein the machine-learned image interpolation model is configured to:
extract, for each of multiple different scales, a respective set of feature values from each of the pair of input images;
generate, for each of the multiple different scales, a respective flow estimate for each of the pair of input images that indicates a respective flow from the interpolation time to the respective capture time;
warp, for each of the multiple different scales, the respective set of feature values for each of the pair of input images according to the respective flow estimate to generate respective warped sets of features; and
generate the interpolated image based on the respective warped sets of features for the pair of input images and the multiple different scales.

16. The one or more non-transitory computer-readable media of claim 15, wherein to generate, for each of the multiple different scales, the respective flow estimate for each of the pair of input images the machine-learned image interpolation model is configured to, for each of the multiple different scales except a coarsest scale:
predict a residual based on (1) the set of feature values for the other input image and the scale and (2) a warped version of the set of feature values for the input image and the scale, wherein the warped version of the set of feature values for the input image and the scale has been warped according to an upsampled flow estimate for the input image from a coarser scale; and
generate the flow estimate for the input image and the scale based on the residual and the upsampled flow estimate for the input image from the coarser scale.

17. The one or more non-transitory computer-readable media of claim 16, wherein to predict the residual the machine-learned image interpolation model is configured to apply one or more learned convolutional filters to (1) the set of feature values for the other input image and the scale and (2) the warped version of the set of feature values for the input image and the scale.

18. The one or more non-transitory computer-readable media of claim 17, wherein, for two or more of the multiple different scales, the learned convolutional filters comprise shared weight values.

19. The one or more non-transitory computer-readable media of claim 15, wherein to warp, for each of the multiple different scales, the respective set of feature values for each of the pair of input images according to the respective flow estimate, the machine-learned image interpolation model is configured to perform a backward bilinear resample operation.

20. The one or more non-transitory computer-readable media of claim 15, wherein to extract, for each of the multiple different scales, the respective set of feature values from each of the pair of input images the machine-learned image interpolation model applies a plurality of learned convolutional filters associated with a plurality of different scales, and wherein at least two of the convolutional filters for at least two of the different scales comprise shared weight values.
